(19) United States
(12) Patent Application Publication
(10) Pub. No.: US 2004/0019722 A1
(43) Pub. Date: Jan. 29, 2004

(54) Method and apparatus for multi-core on-chip semaphore

(76) Inventor: Michael C. Sedmak, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/205,268

(22) Filed: Jul. 25, 2002

(51) Int. Cl. G06F 12/00; G06F 12/14

(52) U.S. Cl. 710/200

(57) ABSTRACT

A method and apparatus for implementing a semaphore on a multi-core processor including a central arbitration unit (CAU) connected to each core thereof. The scheme involves, for each core, outputting a first signal from the core to the CAU to request access to a common resource to perform an operation; and responsive to receipt of a second signal from the CAU, the core performing the operation.

### BACKGROUND OF THE INVENTION

1. Technical Field of the Invention

The present invention generally relates to computer systems. More particularly, and not by way of any limitation, the present invention is directed to method and apparatus for implementing an on-chip semaphore on an integrated circuit chip including multiple processor cores.

2. Description of Related Art

In multi-processor computer systems, a situation commonly occurs in which more than one of the processors simultaneously request access to a common hardware or software resource. In some instances, such resources may be simultaneously accessible by more than one processor. In other instances, a resource may be deemed “non-shareable” and hence accessible by only one processor at a time. One solution to this problem has been to utilize semaphores. In general, semaphores are counters used to control access to shared resources by multiple processes. Semaphores are commonly used as a locking mechanism to prevent a process from accessing a particular resource while another process is performing operations thereon.

A common prior art implementation of a semaphore will now be described in connection with an exemplary computer system that includes multiple processors, a common I/O resource, and system memory all interconnected via a system bus. In operation, when one of the processors wants to access the I/O resource, it must first check the status of the resource by sending a read command via the system bus to a semaphore associated with the I/O resource and stored in system memory. The semaphore returns the status information to the requesting processor. If the resource is available, the requesting processor then sends a write command to the semaphore to change the status of the semaphore from available to unavailable.

In multi-processor systems such as described above, prior to sending the read command to the semaphore, the processor locks the system bus until the read/write cycle is completed. This prevents another process or processor from checking the status of the semaphore concurrently with the requesting processor.

As will be recognized, in addition to preventing other processes or processors from accessing the semaphore during the read/write operation, locking the bus also prevents other processors from communicating with other devices on the system bus, thereby degrading system performance. Clearly, this is an undesirable result.

In addition to the problems described above, use of system memory semaphores gives rise to other problems. Specifically, protected operating systems implement disjointed memory spaces and assign disjointed memory spaces to multiple devices. Therefore, it may be problematic to create a common area for multiple processes to communicate by setting a flag, as the standard method of protection allows a particular process to access only a particular memory area. This impedes use of a memory semaphore, which must be accessed by multiple processors and processes.

Additionally, there is some latency inherent in accessing and modifying system memory semaphores. Further, in order to utilize system memory semaphores, system memory must first be initialized, which is not always convenient or efficient, depending on the circumstances.

### SUMMARY OF THE INVENTION

Accordingly, the present invention advantageously provides a method and apparatus for implementing a semaphore on a multi-core processor without the shortcomings and drawbacks set forth above. In one embodiment, the multi-core processor includes a central arbitration unit (CAU) connected to each core thereof. The scheme involves, for each core, outputting a first signal from the core to the CAU to request access to a common resource to perform an operation; and responsive to receipt of a second signal from the CAU, the core performing the operation.

### BRIEF DESCRIPTION OF THE DRAWINGS

A more complete understanding of the present invention may be had by reference to the following Detailed Description when taken in conjunction with the accompanying drawings wherein:

FIG. 1 is a system block diagram of an embodiment of a computer system for implementing a multi-core on-chip semaphore according to one embodiment of the present invention;

FIG. 2 is a flowchart of an embodiment of exemplary arbitration logic for implementing the multi-core on-chip semaphore illustrated in FIG. 1; and

FIG. 3 is a flowchart of an embodiment of logic implemented by each core of the computer system of FIG. 1 for accessing the multi-core on-chip semaphore thereof.

### DETAILED DESCRIPTION OF THE DRAWINGS

In the drawings, like or similar elements are designated with identical reference numerals throughout the several views thereof, and the various elements depicted are not necessarily drawn to scale.

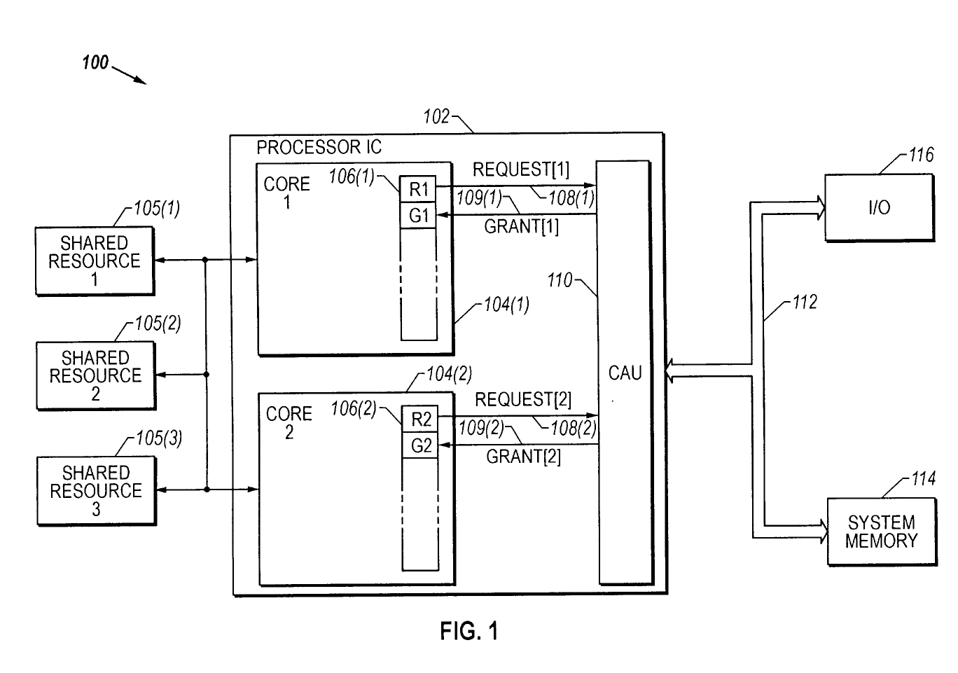

FIG. 1 is a system block diagram of a portion of computer system embodiment 100 including a multi-core processor integrated circuit (“IC”) chip 102. In an exemplary embodiment, the IC chip 102 includes two cores 104(1) and 104(2), although it will be recognized that the IC chip 102 may include more than two cores, and multiple shared resources, represented in FIG. 1 by three shared resources 105(1), 105(2), and 105(3). It will be recognized that the shared resources 105(1), 105(2), 105(3), may also reside on the IC chip 102. Each of the cores 104(1), 104(2) includes or is otherwise associated with a control register 106(1), 106(2), respectively, of which two bits are allocated to semaphore control. A first one of each of these pairs of bits, respectively designated R[1] and R[2] (i.e., request field), is connected to a respective request line (Request[1], designated by reference numeral 108(1), and Request[2], designated by reference numeral 108(2)) for the respective core 104(1), 104(2), and the remaining one of each pair, respectively designated G[1] and G[2] (i.e., grant field), is connected to a grant line (Grant[1], designated by reference numeral 109(1), and Grant[2], designated by reference numeral 109(2)) for the respective core 104(1), 104(2).

The request and grant lines 108(1), 108(2), 109(1) and 109(2), are connected to a central arbitrating unit (“CAU”) 110 also located on the IC chip 102 and comprising arbitration logic that ensures that only one core at time is granted the semaphore, and hence access to the shared resources 105(1)-105(3). In operation, setting a Grant bit (e.g., G[1] or G[2]) to logic zero or logic one drives the corresponding grant line (e.g., Grant[1] 109(1) or Grant[2] 109(2)) low or high, respectively. Similarly, driving a Request line (e.g., Request [1] 108(1) or Request[2] 108(2) low or high sets the corresponding Request bit (R[1] or R[2]) to logic zero or logic one, respectively.

In the embodiment illustrated in FIG. 1, a single semaphore controls access to multiple shared resources; in an alternative embodiment, more than one semaphore may be used to control access to multiple shared resources, it being recognized that a separate Request/Grant bit pair and corresponding lines will be required on each core for each semaphore implemented. The IC chip 102 is connected via one or more buses, represented in FIG. 1 by a bus 112, to system memory 114 and other I/O devices 116 in a conventional manner.

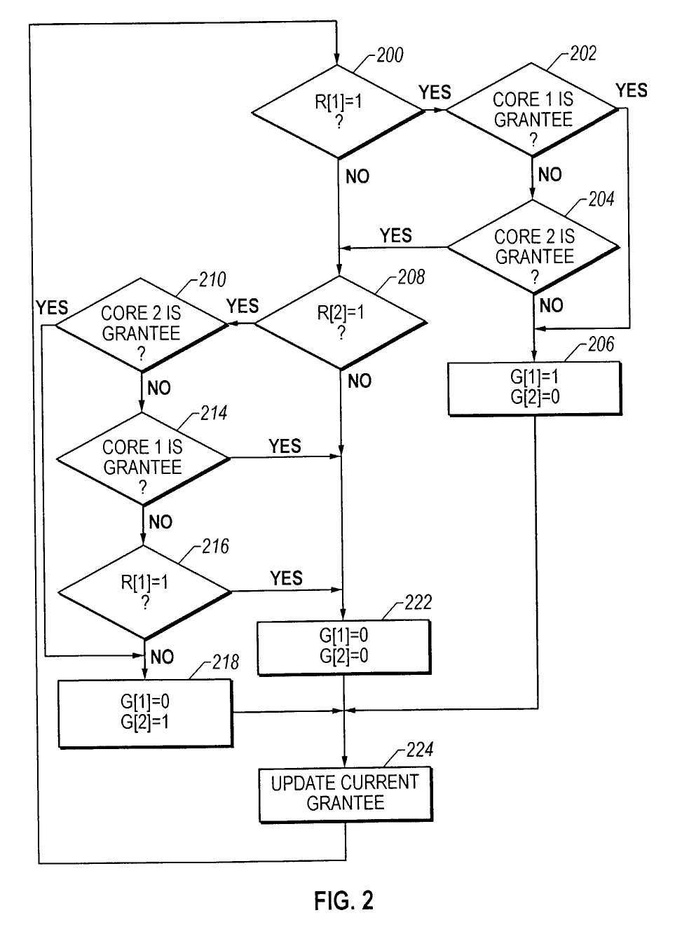

FIG. 2 is a flowchart of exemplary operation of the CAU 110 for ensuring that only one of the cores 104(1), 104(2), at a time is granted the semaphore. It will be recognized that although the arbitration illustrated in FIG. 2 is for only two cores, it may be expanded in a similar fashion to arbitrate among more than two cores. Further, any known or heretofore unknown arbitration technique may be implemented as part of the CAU to resolve contention among an arbitrary number of requesting entities.

In block 200, a determination is made whether the Request[1] line 108(1) is high,, indicating that the core 104(1) has requested the semaphore. In particular, in one embodiment, a determination is made as to whether the bit R[1] is set to one (or “high” or “TRUE”). If so, execution proceeds to block 202, in which a determination is made whether the semaphore is currently granted to the core 104(1) (i.e., whether the core 104(1) is the current grantee of the semaphore). If not, execution proceeds to block 204, in which a determination is made whether the semaphore is currently granted to the core 104(2) (i.e., whether the core 104(2) is the current grantee of the semaphore). If not, execution proceeds to block 206. Similarly, if in block 202 it is determined that the core 104(1) is currently granted the semaphore, execution proceeds to block 206. In block 206, the Grant[1] line 109(1) is driven high and the Grant[2] line is driven low. In particular, in one embodiment, this results in the bit G[1] being set to one and the G[2] bit being set to zero (or “low” or “FALSE”).

If a positive determination is made in block 204, execution proceeds to block 208. Similarly, if in block 200 a negative determination is made, execution also proceeds to block 208. In block 208, a determination is made whether the Request[2] line 108(1) is high, indicating a request for the semaphore has been made by the core 104(2). In particular, in one embodiment, a determination is made as to whether the bit R[2] is set to one. If so, execution proceeds to block 210, in which a determination is made whether the semaphore is currently granted to the core 104(2). If not, execution proceeds to block 214.

In block 214, a determination is made whether the semaphore is currently granted to the core 104(1). If not, execution proceeds to block 216, in which a determination is made whether the Request[1] line 108(1) is high. In particular, in one embodiment, a determination is made as to whether the bit R[1] is set to one. If not, execution proceeds to block 218. Similarly, if in block 210 it is determined that the semaphore is currently granted to the core 104(2), execution proceeds to block 218. In block 218, the Grant[1] line 109(1) driven low and the Grant[2] line 109(2) is driven high. In particular, in one embodiment, this results in the bit G[1] being set to zero and the G[2] bit being set to one.

If a negative determination is made in block 208 or a positive determination is made in either of blocks 214 or 216, execution proceeds to block 222, in which both the Grant[1] line 109(1) and the Grant[2] line 109(2) are driven low. In particular, in one embodiment, this results in both the of the Grant bits G[1] and G[2] being set to zero. Upon completion of any of blocks 206, 218, or 222, execution proceeds to block 224, in which the current grantee of the semaphore is updated (i.e., core 104(1), core 104(2), or neither), and then returns to block 200.

Exemplary pseudo-code for implementing the arbitration logic illustrated and described with reference to FIG. 2 is set forth below:

Inputs

request[1] : request line from core 1 to the arbitration logic
request[2] : request line from core 2 to the arbitration logic

Outputs

grant[1] semaphore granted to core 1
grant[2] semaphore granted to core 2

State

grant_last[1] : core 1 was granted the semaphore
grant_last[2] : core 2 was granted the semaphore
grant_last[1] = FALSE;
grant_last[2] = FALSE;

while (TRUE)

{

if(request[1] AND grant_last[1]
OR
(request[1] AND (NOT grant_last[2])))
{

grant[1] = TRUE;
grant[2] = FALSE;

}
else if((request[2] AND grant_last[2])//keep grant until

done//

OR
(request[2] AND (NOT request[1]) AND (NOT grant_last[1])))
{

grant[1] FALSE;
grant[2] TRUE;

}
else
{

grant[1] = FALSE;
grant[2] = FALSE;

}
grant_last[1] = grant[1];
grant_last[2] = grant[2];

}

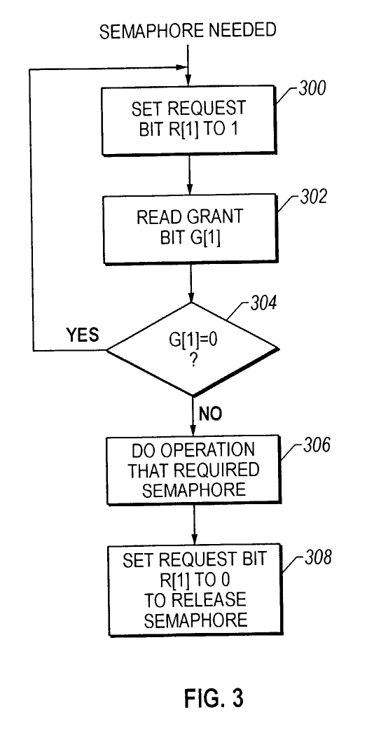

FIG. 3 is a flowchart of the operation of each core for accessing the semaphore. It will be recognized that the operation illustrated in FIG. 3 is implemented on each core 104(1) and 104(2) independently when access to the semaphore is desired by the core. For purposes of example and simplicity, the operation illustrated in FIG. 3 will be described with reference to the core 104(1). Execution begins in block 300 after it is determined that the core 104(1) desires access to the semaphore. In block 300, a first signal is output on the Request line 108(1). In particular, the Request bit of the core 104(1), i.e., Request bit R[1], is set to one (and the Request[1] line 108(1) is driven high). It will be recognized that the arbitration logic described above with reference to FIG. 2 will detect receipt of the first signal (i.e., the driving of the Request[1] line 108(1) high) and respond accordingly by either granting (by transmitting a second signal on the Grant[1] line 109(1) (i.e., driving the Grant[1] line 109(1) high, thus setting the Grant bit G[1] to one)) or effectively denying (by transmitting a third signal on the Grant[1] line 109(1) (i.e., driving the Grant[1] line 109(1) low, thus setting the Grant bit G[1] to zero)) the request. In block 302, the core 104(1) reads the Grant bit G[1]. In block 304, a determination is made whether the Grant bit G[1] is set to 0. If so, execution returns to block 300; otherwise, execution proceeds to block 306. In block 306, the semaphore has been granted, and the operation that required the semaphore is performed. Once the operation is complete, execution proceeds to block 308, in which a fourth signal is transmitted on the Request[1] line 108(1). In particular, the Request[1] line 108(1) is driven low, thus setting the Request bit R[1] to zero, to release the semaphore.

An embodiment of the invention described herein thus provides an on-chip semaphore for use in connection with a multi-core processor, thereby reducing latency and other problems inherent in implementing system memory semaphores. Although the invention has been described with reference to certain implementations, it is to be understood that the forms of the invention shown and described are to be treated as exemplary embodiments only. For example, as previously described, the on-chip semaphore described herein may be implemented on a multi-core processor having any number of cores, with the arbitration logic being modified accordingly. Additionally, multiple semaphores could be implemented for use in controlling access to multiple shared resources. Therefore, all such modifications, extensions, variations, amendments, additions, deletions, substitutions, combinations, and the like are deemed to be within the ambit of the present invention whose scope is defined solely by the claims set forth hereinbelow.

What is claimed is:

1. A method of implementing a semaphore on a multi-core processor for controlling access to a common resource, the multi-core processor including a central arbitration unit connected to each core thereof, the method comprising, for each core:
outputting a first signal from the core to the CAU to request access to the common resource to perform an operation; and
responsive to receipt of a second signal from the CAU, the core performing the operation.

2. The method of claim 1 further comprising, responsive to receipt of a third signal from the CAU, the core continuing to await receipt of the second signal from the CAU.

3. The method of claim 2 further comprising:
responsive to the step of outputting a first signal, the CAU determining whether another one of the cores currently has control of the common resource;
if another one of the cores currently has control of the common resource, the CAU outputting the third signal to the core; and
if another one of the cores does not currently have control of the common resource, the CAU outputting the second signal to the core.

4. The method of claim 2 wherein the first and second signals are logic one signals and the third signal is a logic zero signal.

5. The method of claim 2 further comprising, for each core of the IC chip, upon completion of the step of performing, the core outputting a fourth signal to the CAU.

6. The method of claim 5 wherein the first and second signals are logic one signals and the fourth signal is a logic zero signal.

7. The method of claim 1 further comprising:
responsive to the step of outputting a first signal, the CAU determining whether another one of the cores is currently outputting a first signal to the CAU;
if another one of the cores is currently outputting a first signal to the CAU, the CAU outputting a third signal to the core; and
if another one of the cores is currently outputting a first signal to the CAU, the CAU outputting a second signal to the core.

8. The method of claim 1 further comprising the step of the CAU initially outputting a third signal to the core.

9. A method of implementing a semaphore on a multi-core processor integrated circuit (“IC”) chip for controlling access to a common resource, wherein the IC chip includes a central arbitration unit connected to each core of the IC chip and each core of the IC chip includes a control register comprising a grant field and a request field, the method comprising the steps, for each core of the IC chip:
the core writing a first value to the request field to request access to the common resource, whereupon the on-chip CAU outputs a second value to the core to grant access to the common resource to the core or a third value to deny access to the common resource to the core; and
the core writing a fourth value in the request field to zero to relinquish control of the common resource.

10. The method of claim 9 further comprising the steps, for each core of the IC chip:
responsive to the step of writing a first value to the request field, the CAU determining whether another one of the cores currently has control of the common resource;
responsive to another one of the cores currently having control of the common resource, the CAU outputting a third value to the core; and
responsive to another one of the cores not currently having control of the common resource, the CAU outputting a second value to the core.

11. The method of claim 9 further comprising the steps, for each core of the IC chip:
responsive to the step of writing a first value to the request field, the CAU determining whether another one of the cores currently has a first value stored in its request field;
responsive to another one of the cores currently having a first value stored in its request field, the CAU outputting a third value to the core; and
responsive to another one of the cores currently having a fourth value stored in its request field, the CAU outputting a second value to the core.

12. The method of claim 9 further comprising the step of, for each core of the IC chip, the CAU initially outputting a third value to the core.

13. The method of claim 9 wherein the first and second values comprise a logic one and the third and fourth values comprise a logic zero.

14. Apparatus for implementing a semaphore on a multi-core processor integrated circuit (“IC”) chip for controlling access to a common resource of the IC chip, the apparatus comprising:
an on-chip central arbitration unit (“CAU”), wherein each core of the IC chip is connected to the CAU via a respective request line and a respective grant line; and
an on-chip register associated with each core, the register including a request field and a grant field,
wherein a core outputs a first signal on its request line by setting its request field to a particular value to request access to the common resource to perform an operation in connection therewith, checks its grant line subsequent to the step of setting, and performs the operation if a second signal is received on its grant line.

15. The apparatus of claim 14 wherein the core continues to check its grant line if a third signal is received on its grant line.

16. The apparatus of claim 15 wherein, responsive to receipt of a first signal from the core on its request line, the CAU determines whether another one of the cores currently has control of the common resource and if so, the CAU outputs the third signal on the grant line; otherwise, the CAU outputs the second signal on the grant line.

17. The apparatus of claim 15 wherein the first and second signals are logic one signals and the third signal is a logic zero signal.

18. The apparatus of claim 15 wherein upon completion of performance of the operation, the core outputs a fourth signal on its request line.

19. The apparatus of claim 18 wherein the first and second signals are logic one signals and the fourth signal is a logic zero signal.

20. The apparatus of claim 14 wherein responsive to receipt of a first signal from the core on its request line, the CAU determines whether another one of the cores is currently outputting a first signal on its request line and if so, the CAU outputs a third signal on the grant line of the core; otherwise, the CAU outputs a second signal on the grant line of the core.

21. The apparatus of claim 14 wherein the CAU initially outputs a third signal on the grant line of each core.
